(19) United States
(12) Patent Application Publication
(10) Pub. No.: US 2002/0012850 A1
(43) Pub. Date: Jan. 31, 2002

(54) Silane compounds as additive in electrolytes for electrochemical cells

(75) Inventors: Michael Schmidt, Darmstadt (DE); Andreas Kuhner, Darmstadt (DE); Dagmar Petigk, Russelsheim (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: MERCK PATENTGESELLSCHAFT, Darmstadt (DE)

(21) Appl. No.: 09/875,047

(22) Filed: Jun. 7, 2001

(30) Foreign Application Priority Data
Jun. 7, 2000 (DE) 100 27 626.1

(51) Int. Cl. H01M 10/40

(52) U.S. Cl. 429/324; 429/326

(57) ABSTRACT

Silane compounds of the formula SiR¹R²R³R⁴ wherein R¹ to R⁴ are as defined herein are useful as additives in electrolytes for improving the properties of electrochemical cells.

The invention relates to the use of silane compounds as additives in electrolytes for improving the properties of electrochemical cells.

Lithium ion batteries are among the most promising systems for mobile applications. Fields of use range from high-value electronic equipment (e.g. mobile telephones, camcorders) to batteries for electrically driven motor vehicles.

These batteries consist of cathode, anode, separator and a nonaqueous electrolyte. As cathode, use is typically made of Li(MnMe_{z})₂O₄, Li(CoMe_{z})O₂, Li(CoNiₓMe_{z})O₂, whererin Me is metal, or other lithium intercalations and insertion compounds. Anodes can consist of lithium metal, carbon, graphite, graphitic carbon or other lithium intercalation and insertion compounds or alloys. Electrolytes used are solutions of lithium salts such as LiPF₆, LiBF₄, LiClO₄, LiAsF₆, LiCF₃SO₃, LiN(CF₃SO₂)₂ or LiC(CF₃SO₂)₃ and mixtures thereof in aprotic solvents.

Owing to the sensitivity to water and other protic contaminants of the electrolyte salt LiPF₆ frequently used in lithium ion batteries, these electrolytes always have a measurable content of hydrofluoric acid. In addition to this, the electrolyte has an HF content of at least 50 ppm resulting from its method of manufacture. In addition, HF can be formed by heating of the system. The hydrofluoric acid formed reacts readily with the various components of the battery.

Graphite electrodes are usually coated with alkyl carbonates, lithium carbonates, lithium hydroxides and lithium oxides. The hydrofluoric acid reacts with this coating. In electrolytes comprising LiPF₆ as electrolyte salt, it has been able to be shown that the impedance of the battery increases continually. This is attributable to attack on the carbonate coating and the formation of an LiF film.

HF reacts with the coating according to the following equations:

Li₂CO₃+2HF→2LiF+H₂CO₃

LiOH+HF→LiF+H₂O

Li₂O+2HF→2LiF+H₂O.

In contrast to the original coating, the LiF-containing film has very poor, if any, permeability to Li ions.

The prior art discloses the addition of additives which are intended to react with HF and thus prevent the formation of the LiF film.

Many additives for use in lithium ion batteries have been mentioned in the literature. Thus, for example, tributylamine is used as an HF trap. This additive reduces the HF content very effectively, but it is not stable to electrochemical oxidation. It is irreversibly decomposed above about 3.5 V relative to Li/Li⁺.

In JP 08321311, various acetates and oxalates and also silanes are employed as additives. These form a layer on the anode which is said to prevent the reactions between electrolyte and anode.

### SUMMARY OF THE INVENTION

In contrast to the prior art, the present invention does not seek to remove HF from the electrolyte or to form a new film. Instead, the new starting point aims to dissolve lithium fluoride which has been formed and thus stabilize the impedance of the battery.

It is therefore an object of the present invention to provide additives which counter film formation on the electrodes and have a sufficiently high electrochemical stability.

Upon further study of the specification and appended claims, further objects and advantages of this invention will become apparent to those skilled in the art.

These objects of the invention are achieved by the use of compounds of the following formula:

SiR¹R²R³R⁴

where

R¹-R⁴ are each H,

C_{y}F_{2y+1-z}H_{z},

OC_{y}F_{2y+1-z}H_{z},

OC(O)C_{y}F_{2y+1-z}H_{z},

OSO₂C_{y}F_{2y+1-z}H_{z}

with 1≦x<6, 1≦y≦8 and 0≦z≦2y+1 and

R¹-R⁴ can also each be, independently, an aromatic ring selected from phenyl and naphthyl, which in each case are unsubstituted or monosubstituted or polysubstituted by F, C_{y}F_{2y+1-z}H_{z}, OC_{y}F_{2y+1-z}H_{z}, OC(O)C_{y}F_{2y+1-z}H_{z}, OSO₂C_{y}F_{2y+1-z}H_{z}, or N(CₙF_{2n+1-z}H_{z})₂, or

a heterocyclic aromatic ring selected from pyridyl, pyrazyl and pyrimidyl, which in each case are unsubstituted or monosubstituted or polysubstituted by F, C_{y}F_{2y+1-z}H_{z}, OC_{y}F_{2y+1-z}H_{z}, OC(O)C_{y}F_{2y+1-z}H_{z}, OSO₂C_{y}F_{2y+1-z}H_{z}, or N(CₙF_{2n+1-z}H_{z})₂,

The silane compounds can be used as additives in electrolytes containing a lithium-containing inorganic electrolyte salt or lithium-containing organic electrolyte salt dissolved in aprotic solvents.

The silane compounds are dissolved in electrolytes which are customarily used in electrochemical cells, preferably in nonaqueous secondary lithium batteries. It has been found that tetracoordinated silane compounds, in particular tetramethoxysilane, ethyltriacetoxysilane, diphenylmethoxysilane, difluorodiphenylsilane and triethylsilyl fluoromethanesulfonate, are suitable additives for electrochemical cells.

It has surprisingly been found that silane compounds can dissolve LiF to high concentrations in organic aprotic solvents. The additives used according to the invention can prevent the formation of an LiF film on the electrodes. This enables the impedance of the battery to be stabilized.

The additives have good electrochemical stability. It has been found that the oxidation stability of the silane compounds is sufficiently high for use in electrochemical cells, preferably in lithium ion batteries.

The silane compounds can be used in electrolytes comprising conventional electrolyte salts. Suitable electrolyte salts are, for example, ones selected from the group LiPF₆, LiBF₄, LiClO₄, LiAsF₆, LiCF₃SO₃, LiN(CF₃SO₂)₂, LiN(CF₃CF₂SO₂)₂ or LiC(CF₃SO₂)₃ and mixtures thereof.

The electrolytes may further comprise organic isocyanates (DE 199 44 603) to reduce the water content.

It is also possible for compounds of the following formula (see DE 19941566) to be present in the elctrolytes.

[([R¹(CR²R³)ₖ]ₗAₓ)_{y}Kt]^{+ -}N(CF₃)₂

where

Kt is N, P, As, Sb, S, Se

A is N, P, P(O), O, S, S(O), SO₂, As, As(O), Sb, Sb(O)

R¹, R² and R³ are identical or different and are each

H, halogen, substituted or unsubstituted alkyl CₙH₂ₙ₊₁, substituted or unsubstituted alkenyl having 1-18 carbon atoms and one or more double bonds, substituted or unsubstituted alkynyl having 1-18 carbon atoms and one or more triple bonds, substituted or unsubstituted cycloalkyl CₘH₂ₘ₋₁, monosubstituted or polysubstituted or unsubstituted phenyl, substituted or unsubstituted heteroaryl,

where

A may be included in various positions in R¹, R² and/or R³,

Kt can be included in a cyclic or heterocyclic ring,

the groups bound to Kt may be identical or different,

and

n is 1-18

m is 3-7

k is 0, 1-6

l is 1 or 2 when x=1 and is 1 when x=0

x is 0, 1

y is 1-4.

The process for preparing these compounds comprises reacting an alkali metal salt of the formula

D^{+ -}N(CF₃)₂

where D⁺ is selected from the group of alkali metals, in a polar organic solvent with a salt of the formula

[([R¹(CR²R³)ₖ]ₗAₓ)_{y}Kt]^{+ -}E

where 1 2 3

Kt, A, R¹, R², R³, k, l, x and y are as defined above and

⁻E is F⁻, Cl⁻, Br⁻, I⁻, BF₄⁻, ClO₄⁻, AsF₆⁻, SbF₆⁻ or PF₆⁻.

The silane compounds used according to the invention can also be present in electrolytes comprising compounds of the formula

X—(CYZ)ₘ—SO₂N(CR¹R²R³)₂

where

X is H, F, Cl, CₙF₂ₙ₊₁, CₙF₂ₙ₋₁, (SO₂)ₖN(CR¹R²R³)₂

Y is H, F, Cl

Z is H, F, Cl

R¹, R², R³ are each, independently, H, alkyl (e.g., having 1 to 8 C atoms), fluoroalkyl (e.g., having 1 to 8 C atoms), cycloalkyl (e.g., having 3 to 6 C atoms)

m is 0-9 and when X=H, m≠0

n is 1-9

k is 0 when m=0 and k=1 when m=1-9.

These compounds can be prepared by reacting partially fluorinated or perfluorinated alkylsulfonyl fluorides with dimethylamine in organic solvents (DE 199 466 73).

It is also possible to use electrolytes comprising complex salts of the formula (DE 199 51 804)

M^{x+}[EZ]_{x/y}^{y-}

where:

x, y are each 1, 2, 3, 4, 5, 6

M^{x+} is a metal ion

E is a Lewis acid selected from BR¹R²R³, AlR¹R²R³, PR¹R²R³R⁴R⁵, AsR¹R²R³R⁴R⁵, and VR¹R²R³R⁴R⁵,

R¹ to R⁵ are identical or different and are in each case individually

a halogen (F, Cl, Br),

an alkyl or alkoxy radical (C₁ to C₈) which in each case is unsubstituted or partially or fully substituted by F, Cl, or Br,

an aromatic ring selected from phenyl, naphthyl, anthracenyl and phenanthrenyl, which may be bound via oxygen, and which is unsubstituted or monosubstituted to hexasubstituted by alkyl (C₁ to C₈), F, Cl, or Br,

an aromatic heterocyclic ring selected from pyridyl, pyrazyl and pyrimidyl, which may be bound via oxygen, and which is unsubstituted or monosubstituted to tetrasubstituted by alkyl (C₁ to C₈), F, Cl, or Br,

or together pairs of R¹ to R⁵ can be

an aromatic ring selected from phenylene, naphthylene, anthracenylene and phenanthrenylene, which may be bound via oxygen, and which is unsubstituted or monosubstituted to hexasubstituted by alkyl (C₁ to C₈), F, Cl, or Br,

an aromatic heterocyclic ring selected from pyridylene, pyrazylene and pyrimidylen, which may be bound via oxygen, and which is unsubstituted or monosubstituted to tetrasubstituted by alkyl (C₁ to C₈), F, Cl, or Br,

in which the pair of R groups are joined directly to one another by a single or double bond, and

Z is OR⁶, NR⁶R⁷, CR⁶R⁷R⁸, OSO₂R⁶, N(SO₂R⁶)(SO₂R⁷), C(SO₂R⁶)(SO₂R⁷)(SO₂R⁸) , OCOR⁶, where

R⁶ to R⁸ are each, independently, a hydrogen atom or a group as defined for R¹ to R⁵.

These compounds can be prepared by reacting an appropriate boron or phosphorus Lewis acid-solvent adduct with a lithium or tetraalkylammonium imide, methanide or triflate.

It is also possible for borate salts (see DE 199 59 722) of the following formula to be present in the electrolyte

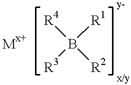

where:

M is a metal ion, tetraalkylammonium ion, PR^{a}R^{b}R^{c}R^{d}, P(NR^{a}R^{b})ₖR^{c}ₘR^{d}₄₋ₖ₋ₘ wherein k is 1-4, m is 0-3 and k+m≦4, C(NR^{a}R^{b}) (NR^{c}R^{d})(NR^{e}R^{f}), C(R^{z})₃, tropylium or a heterocyclic ring containing P, N, S or O, or a fused heterocyclic system containing three rings, wherein R^{a} to R^{f} are each independently H, alkyl having 1 to 8 C atoms or aryl having up to 8 C atoms, in which the aklkyl and aryl groups are unsubtituted or partially substituted by F, Cl, or Br,

R^{z} is an aromatic or substituted aromatic ring,

x, y are each 1, 2, 3, 4, 5 or 6, and

R¹ to R⁴ are identical or different alkoxy or carboxy radicals (C₁-C₈) which are optionally bonded directly to one another by a single or double bond.

These borate salts are prepared by reacting a lithium tetraalkoxyborate or a 1:1 mixture of lithium alkoxide with a boric ester in an aprotic solvent with a suitable hydroxyl or carboxyl compound in a ratio of 2:1 or 4:1.

The compounds used according to the invention can also be employed in electrolytes comprising lithium fluoroalkylphosphates of the formula

Li⁺[PFₓ(C_{y}F_{2y+1-z}H_{z})₆₋ₓ]⁻

where

1≦x≦5

3≦y≦8

0≦z≦2y+1

and the ligands (C_{y}F_{2y+1-z}H_{z}) may be identical or different, with the exception of compounds of the formula

Li⁺[PFₐ(CH_{b}F_{c}(CF₃)_{d})ₑ]⁻

in which a is an integer from 2 to 5, b=0 or 1, c=0 or 1, d=2 and

e is an integer from 1 to 4, with the provisos that b and c are not at the same time 0 and the sum of a+e is 6 and the ligands (CH_{b}F_{c}(CF₃)_{d}) may be identical or different (DE 100 089 55). The process for preparing these lithium fluoroalkylphosphates comprises fluorinating at least one compound of the formula

HₘP(CₙH₂ₙ₊₁)₃₋ₘ,

OP(CₙH₂ₙ₊₁)₃,

ClₘP(CₙH₂ₙ₊₁)₃₋ₘ,

FₘP(CₙH₂ₙ₊₁)₃₋ₘ,

ClₒP(CₙH₂ₙ₊₁)₅₋ₒ,

FₒP(CₙH₂ₙ₊₁)₅₋ₒ,

where in each case

0<m<2, 3<n<8 and 0<o<4,

by electrolysis in hydrogen fluoride, fractionating the resulting mixture of fluorination products by extraction, phase separation and/or distillation, and reacting the resulting fluorinated alkylphosphorane in an aprotic solvent or solvent mixture with lithium fluoride in the absence of moisture, and purifying and isolating the resulting salt by customary methods.

The compounds used according to the invention can also be employed in electrolytes comprising salts of the formula

Li[P(OR¹)ₐ(OR² )_{b}(OR³)_{c}(OR⁴ )_{d}Fₑ]

where 0<a+b+c+d≦5 and a+b+c+d+e=6, and R¹ to R⁴ are, independently of one another, alkyl, aryl or heteroaryl radicals, where pairs of the radicals R¹ to R⁴ may also together form alkylene, arylene or heteroarylene groups, the pairs being joined directly to one another by a single or double bond (DE 100 16 801). These compounds are prepared by reacting phosphorus(V) compounds of the formula

P(OR¹)ₐ(OR²)_{b}(OR³)_{c}(OR⁴)_{d}Fₑ

where 0<a+b+c+d≦5 and a+b+c+d+e=5, and R¹ to R⁴ are as defined above, with lithium fluoride in the presence of an organic solvent.

It is also possible for ionic liquids of the folowing formula (see DE 100 265 65) to be present in the elctrolyte

K⁺A⁻

where:

K⁺ is a cation selected from

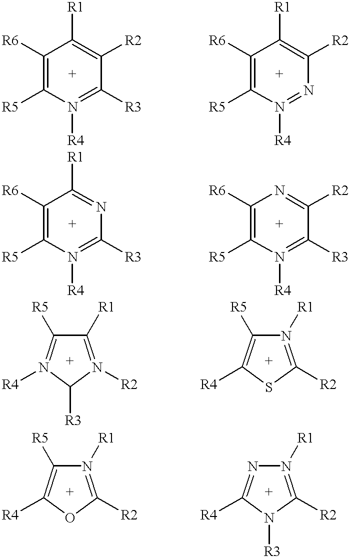

where

R¹ to R⁶ are identical or different and are each individually

—H,

halogen,

an alkyl radical (C₁ to C₈), which is unsubstituted or partially or fully substituted by further groups, preferably F, Cl, N(CₙF₍₂ₙ₊₁₋ₓ₎Hₓ)₂, O(CₙF₍₂ₙ₊₁₋ₓ₎Hₓ), SO₂(CₙF₍₂ₙ₊₁₋ₓ₎Hₓ) or CₙF₍₂ₙ₊₁₋ₓ₎Hₓ where 1<n<6 and 0<x≦13,

a phenyl radical which is unsubstituted or partially or fully substituted by further groups, preferably F, Cl, N(CₙF₍₂ₙ₊₁₋ₓ₎Hₓ)₂, O(CₙF₍₂ₙ₊₁₋ₓ₎Hₓ), SO₂(CₙF₍₂ₙ₊₁₋ₓ₎Hₓ) or CₙF₍₂ₙ₊₁₋ₓ₎Hₓ where 1<n<6 and 0<x≦13, or

one or more pairs of adjacent R¹ to R⁶ can also be an alkylene or alkenylene radical having up to 8 C atoms and which is unsubstituted or partially or fully substituted by further groups, preferably halogen (such as F and Cl), N(CₙF₍₂ₙ₊₁₋ₓ₎Hₓ)₂, O(CₙF₍₂ₙ₊₁₋ₓ₎Hₓ), SO₂(CₙF₍₂ₙ₊₁₋ₓ₎Hₓ) or CₙF₍₂ₙ₊₁₋ₓ₎Hₓ where 1<n<6 and 0<x≦13; and

A⁻ is an anion selected from

[B(OR⁷)ₙ(OR⁸)ₘ(OR⁹)ₒ(OR¹⁰)ₚ]⁻

where

0≦n, m, o, p≦4, and m+n+o+p=4, and

R⁷ to R¹⁰ are different or identical and are each, individually,

an aromatic ring selected from phenyl, naphthyl, anthracenyl and phenanthrenyl, which is unsubstituted or monosubstituted or polysubstituted by CₙF₍₂ₙ₊₁₋ₓ₎Hₓ, where 1<n<6 and 0<x≦13, or halogen (F, Cl or Br),

an aromatic heterocyclic ring selected from pyridyl, pyrazyl and pyrimidyl, which is unsubstituted or monosubstituted or polysubstituted by CₙF₍₂ₙ₊₁₋ₓ₎Hₓ, where 1<n<6 and 0<x≦13, or halogen (F, Cl or Br), or

an alkyl radical (C₁ to C₈), which is unsubstituted or partially or fully substituted by further groups, preferably F, Cl, , N(CₙF₍₂ₙ₊₁₋ₓ₎Hₓ)₂, O(CₙF₍₂ₙ₊₁₋ₓ₎Hₓ), SO₂(CₙF₍₂ₙ₊₁₋ₓ₎Hₓ), or CₙF₍₂ₙ₊₁₋ₓ₎Hₓ, where 1<n<6 and 0<x≦13; or

one or more pairs of R⁷ to R¹⁰ can also form

an aromatic ring selected from phenylene, naphthylene, anthracenylene and phenanthrenylene, which is unsubstituted or monosubstituted or polysubstituted by CₙF₍₂ₙ₊₁₋ₓ₎Hₓ, where 1<n<6 and 0<x≦13, or halogen (F, Cl or Br),

an aromatic heterocyclic ring selected from pyridylene, pyrazylene and pyrimidylene, which is unsubstituted or monosubstituted or polysubstituted by CₙF₍₂ₙ₊₁₋ₓ₎Hₓ, where 1<n<6 and 0<x≦13, or halogen (F, Cl or Br), or

an alkylene or alkenylene radical having up to 8 C atoms and which is unsubstituted or partially or fully substituted by further groups, preferably halogen (such as F and Cl), N(CₙF₍₂ₙ₊₁₋ₓ₎Hₓ)₂, O(CₙF₍₂ₙ₊₁₋ₓ₎Hₓ) , SO₂(CₙF₍₂ₙ₊₁₋ₓ₎Hₓ) or CₙF₍₂ₙ₊₁₋ₓ₎Hₓ where 1<n<6 and 0<x≦13; or

or OR⁷ to OR¹⁰,

individually or together, are an aromatic (having, e.g., 6 to 14 C atoms) or aliphatic (having, e.g., 1 to 6 C atoms) carboxyl, dicarboxyl, oxysulfonyl or oxycarbonyl radical, which is unsubstituted or partially or fully substituted by further groups, preferably F, Cl, N(CₙF₍₂ₙ₊₁₋ₓ₎Hₓ)₂, O(CₙF₍₂ₙ₊₁₋ₓ₎Hₓ), SO₂(CₙF₍₂ₙ₊₁₋ₓ₎Hₓ) or CₙF₍₂ₙ₊₁₋ₓ₎Hₓ, where 1<n<6 and O<x≦13.

Ionic liquids K⁺A⁻ may also be present in the elctrolyte (see DE 100 279 95) where K⁺ is as defined above and

A⁻ is an ion of the formula

[PFₓ(C_{y}F_{2y+1-z}H_{z})₆₋ₓ]⁻

where

1≦x<6

1≦y≦8 and

0≦z≦2y+1.

The silane compounds used according to the invention can also be present in electrolytes comprising compounds of the following formula (see U.S. patent application 60/230,711):

NR¹R²R³

where

R¹ and R² are each H, C_{y}F_{2y+1-z}H_{z} or (CₙF₂ₙ₋ₘHₘ)X, where X is an aromatic or heterocyclic radical, and

R³ is (CₙF₂ₙ₋ₘHₘ)Y, where Y is a heterocyclic radical, or

(CₒF₂ₒ₋ₚHₚ)Z, where Z is an aromatic radical,

and n, m, o, p, y and z fulfil the following conditions:

0≦n≦6,

0≦m≦2n,

2≦o≦6,

0≦p≦2o,

1≦y≦8 and

0≦z≦2y+1,

to reduce the acid content in aprotic electrolyte systems in electrochemical cells.

It is also possible for fluoroalkylphosphates of the following formula to be present in the electrolyte

Mⁿ⁺[PFₓ(C_{y}F_{2y+1-z}H_{z})₆₋ₓ]ₙ⁻

where

1≦x≦6

1≦y≦8

0≦z≦2y+1

1≦n≦3 and

Mⁿ⁺ is a monovalent to trivalent cation, in particular:

NR¹R²R³R⁴,

PR¹R²R³R⁴,

P(NR¹R²)ₖR³ₘR⁴₄₋ₖ₋ₘ (where k=1-4, m=0-3 and k+m≦4),

C(NR¹R²)(NR³R⁴)(NR⁵R⁶),

C(aryl)₃, Rb or tropylium,

where R¹ to R⁸ are each, independently, H, alkyl having 1 to 8 C atoms, or aryl having up to 8 C atoms, in which the alkyl and aryl groups are unsubstituted or partially substituted by F, Cl or Br,

with the exception of Mⁿ⁺=Li⁺, Na⁺, Cs⁺, K⁺ and Ag⁺. These fluoroalkylphosphates are obtainable by reacting phosphoranes with a fluoride or metal fluoroalkylphosphates with a fluoride or chloride in organic aprotic solvents (DE 100 388 58).

The electrolyte can also comprise a mixture comprising

a) at least one lithium fluoroalkylphosphate salt of the formula

Li⁺[PFₓ(C_{y}F_{2y+1-z}H_{z})₆₋ₓ]⁻

where

1≦x≦5

1≦y≦8 and

0≦z≦2y+1

and the ligands (C_{y}F_{2y+1-z}H_{z}) are in each case identical or different and

b) at least one polymer (DE 100 58 264).

Tetrakisfluoroalkylborate salts of the following formula can also be present in the electrolyte

Mⁿ⁺([BR₄]⁻)ₙ

where

Mⁿ⁺ is a monovalent, divalent or trivalent cation,

the ligands R are in each case identical and are each (CₓF₂ₓ₊₁) where 1≦x≦8

and n=1, 2 or 3 (DE 100 558 11). The process for preparing these tetrakisfluoroalkylborate salts comprises fluorinating at least one compound of the formula Mⁿ⁺([B(CN)₄]⁻)ₙ where Mⁿ⁺ and n are as defined above, by reaction with at least one fluorinating agent in at least one solvent and purifying and isolating the resulting fluorinated compound by customary methods.

The electrolyte can also comprise borate salts of the formula

Mⁿ⁺[BFₓ(C_{y}F_{2y+1-z}H_{z})₄₋ₓ]ₙ⁻

where:

1<x<3, 1≦y≦8 and 0≦z≦2y+1 and

M is a monovalent to trivalent cation (1≦n≦3), with the exception of potassium and barium,

in particular:

Li,

NR¹R²R³R⁴, PR⁵R⁶R⁷R⁸, P(NR⁵R⁶)ₖR⁷ₘR⁸₄₋ₖ₋ₘ (where k=1-4, m=0-3 and k+m≦4) or

C(NR⁵R⁶)(NR⁷R⁸)(NR⁹R¹⁰), where

R¹ to R⁴ are each, independently, C_{y}F_{2y+1-z}H_{z} and

R⁵ to R¹⁰ are each, independently, H or C_{y}F_{2y+1-z}H_{z} or

R¹ to R¹⁰ can also each independently be an aromatic heterocyclic cation, in particular a nitrogen- and/or oxygen- and/or sulfur-containing aromatic heterocyclic cation (see DE 101 031 89).

The process for preparing these compounds comprises

a) reacting BF₃-solvent complexes 1:1 with alkyllithium while cooling, slowly warming the mixture and then removing most of the solvent and subsequently filtering off the solid and washing it with a suitable solvent, or

b) reacting lithium salts in a suitable solvent 1:1 with B(CF₃)F₃⁻ salts, stirring the mixture at elevated temperature and, after removing the solvent, admixing the reaction mixture with aprotic nonaqueous solvents, preferably solvents which are used in electrochemical cells, and drying, or

c) reacting B(CF₃)F₃⁻ salts 1:1 to 1:1.5 with lithium salts in water at elevated temperature and heating the mixture at the boiling point for from 0.5 to 2 hours, removing the water and admixing the reaction mixture with aprotic nonaqueous solvents, preferably solvents which are used in electrochemical cells, and drying.

The electrolyte can also comprise fluoroalkylphosphate salts of the formula

Mⁿ⁺([PFₓ(C_{y}F_{2y+1-z}H_{z})₆₋ₓ]⁻)ₙ

where

Mⁿ⁺ is a monovalent, divalent or trivalent cation,

1≦x≦5,

1≦y≦8 and

0≦z≦2y+1, n=1, 2 or 3 and the ligands (C_{y}F_{2y+1-z}H_{z}) are in each case identical or different, with the exception of the fluoroalkylphosphate salts in which Mⁿ⁺ is a lithium cation and the salts

M⁺([PF₄(CF₃)₂]⁻) where M⁺=Cs⁺, Ag⁺ or K⁺,

M⁺([PF₄(C₂F₅)₂]⁻) where M⁺=Cs⁺,

M⁺([PF₃(C₂F₅)₃]⁻) where M⁺=Cs⁺, K⁺, Na⁺ or para-Cl(C₆H₄)N₂⁺,

M⁺([PF₃(C₃F₇)₃]⁻) where M⁺=Cs⁺, K⁺, Na⁺, para-Cl(C₆H₄)N₂⁺ or para-O₂N(C₆H₄)N₂⁺ (DE 100 558 12). The process for preparing these fluoroalkylphosphate salts comprises fluorinating at least one compound of the formula

HᵣP(CₛH₂ₛ₊₁)₃₋ᵣ,

OP(CₛH₂ₛ₊₁)₃,

ClᵣP(CₛH₂ₛ₊₁)₃₋ᵣ,

FᵣP(CₛH₂ₛ₊₁)₃₋ᵣ,

ClₜP(CₛH₂ₛ₊₁)₅₋ₜ and/or

FₜP(CₛH₂ₛ₊₁)₅₋ₜ,

where in each case

0≦r≦2

3≦s≦8 and

0≦t≦4,

by electrolysis in hydrogen fluoride, fractionating the resulting mixture of fluorination products and reacting the resulting fluorinated alkylphosphorane in an aprotic solvent or solvent mixture with a compound of the formula Mⁿ⁺(F⁻)ₙ where Mⁿ⁺ and n are as defined above, in the absence of moisture and purifying and isolating the resulting fluoroalkylphosphate salt by customary methods.

The compounds used according to the invention can also be employed in electrolytes for electrochemical cells which comprise anode material made of coated metal cores selected from Sb, Bi, Cd, In, Pb, Ga and tin or alloys thereof (DE 100 16 024). The process for producing this anode material comprises

a) preparing a suspension or a sol of the metal or alloy core in urotropin,

b) emulsifying the suspension with C₅-C₁₂-hydrocarbons,

c) precipitating the emulsion onto the metal or alloy cores and

d) converting the metal hydroxides or oxyhydroxides into the corresponding oxide by heating the system.

The compounds used according to the invention can also be employed in electrolytes for electrochemical cells having cathodes comprising customary lithium intercalation and insertion compounds or else electrochemical cells having cathode materials made of lithium mixed oxide particles coated with one or more metal oxides (DE 199 22 522). They can also be made of lithium mixed oxide particles which are coated with one or more polymers (DE 199 46 066) and are obtained by a process in which the particles are suspended in a solvent and the coated particles are subsequently filtered off, dried and, if appropriate, calcined. The compounds used according to the invention can likewise be employed in systems having cathodes which are made of lithium mixed oxide particles which are coated with one or more layers of alkali metal compounds and metal oxides (DE 100 14 884). The process for producing these materials comprises suspending the particles in an organic solvent, adding an alkali metal salt compound suspended in an organic solvent, adding metal oxides dissolved in an organic solvent, admixing the suspension with a hydrolysis solution and subsequently filtering off, drying and calcining the coated particles. The compounds used according to the invention can likewise be employed in systems which comprise anode materials comprising doped tin oxide (DE 100 257 61). This anode material is produced by

a) admixing a tin chloride solution with urea,

b) admixing the solution with urotropin and a suitable doping compound,

c) emulsifying the resulting sol in petroleum ether,

d) washing the gel obtained and removing the solvent by filtration with suction and

e) drying and heat-treating the gel.

The compounds used according to the invention can likewise be employed in systems which comprise anode materials comprising reduced tin oxide (DE 100 257 62). This anode material is produced by

a) admixing a tin chloride solution with urea,

b) admixing the solution with urotropin,

c) emulsifying the resulting sol in petroleum ether,

d) washing the gel obtained and removing the solvent by filtration with suction,

e) drying and heat-treating the gel and

f) treating the SnO₂ obtained with a reducing gas stream in an oven through which gas can be passed.

The invention accordingly provides an electrolyte for nonaqueous electrochemical cells, preferably for secondary lithium batteries, whose performance is improved, e.g. the formation of an LiF film is minimized with corresponding reduction of the impedance, by addition of specific additives.

The invention will now be illustrated by a general example.

Examination of the Solubility of Lithium Fluoride

From 0.01 to 10% by weight of LiF, based on the electrolyte, are added to a solvent mixture selected from the group consisting of EC, DMC, PC, DEC, EC, PC, BC, VC, cyclopentanones, sulfolanes, DMS, 3-methyl-1,3-oxazolidin-2-one, DMC, DEC, γ-butyrolactone, EMC, MPC, BMC, EPC, BEC, DPC, 1,2-diethoxymethane, THF, 2-methyltetrahydrofuran, 1,3-dioxolane, methyl acetate, ethyl acetate and mixtures thereof. The suspension is stirred at room temperature.

For comparison, the same solution is, in parallel, admixed with from 0.01 to 10% by weight, preferably from 0.1 to 5% by weight, of silanes of the formula (I)

SiR¹R²R³R⁴ (I)

where

R¹-R⁴ are each H,

C_{y}F_{2y+1-z}H_{z},

OC_{y}F_{2y+1-z}H_{z},

OC(O)C_{y}F_{2y+1-z}H_{z},

OSO₂C_{y}F_{2y+1-z}H_{z},

where 1≦x≦6, 1≦y≦8 and 0≦z≦2y+1 and R¹-R⁴ are identical or different and are each

an aromatic ring selected from the group consisting of phenyl and naphthyl which may be unsubstituted or monosubstituted or polysubstituted by F, C_{y}F_{2y+1-z}H_{z} or OC_{y}F_{2y+1-z}H_{z}, OC(O)C_{y}F_{2y+1-z}H_{z}, OSO₂C_{y}F_{2y+1-z}H_{z}, N(CₙF_{2n+1-z}H_{z})₂, or

a heterocyclic aromatic ring selected from the group consisting of pyridyl, pyrazyl and pyrimidyl which may each be monosubstituted or polysubstituted by F, C_{y}F_{2y+1-z}H_{z} or OC_{y}F_{2y+1-z}H_{z}, OC(O)C_{y}F_{2y+1-z}H_{z}, OSO₂C_{y}F_{2y+1-z}H_{z}, N(CₙF_{2n+1-z}H_{z})₂. Particular preference is given to using silane compounds selected from the group consisting of tetramethoxysilane, ethyltriacetoxysilane, diphenylmethoxysilane, difluorodiphenylsilane and triethylsilyl fluoromethanesulfonate. The suspension is stirred at room temperature.

The silanes dissolve lithium fluoride to differing degrees.

### BRIEF DESCRIPTION OF THE DRAWINGS

Various other features and attendant advantages of the present invention will be more fully appreciated as the same becomes better understood when considered in conjunction with the accompanying drawings, wherein:

FIG. 1 is a cyclovoltagram obtained using ethyltriacetoxysilane as additive;

FIGS. 2-3 are graphs of the cycling results for additive-free electrolyte; and

FIGS. 4-7 are graphs of cycling results for the electrolytes containing silane compounds in accordance with the invention.

The following examples further illustrate the invention without restricting it.

In the foregoing and in the following examples, all temperatures are set forth uncorrected in degrees Celsius; and, unless otherwise indicated, all parts and percentages are by weight.

The entire disclosure of all applications, patents and publications, cited above and below, and of corresponding German Application No. DE 100 27 626.1, filed Jun. 7, 2000 is hereby incorporated by reference.

### EXAMPLES

### Example 1

Solubility of LiF in EC with and without Si Additive

0.5 or 1.0 mol/l of LiF are added to 500 ml of EC/DMC (1:1). The suspensions are stirred at room temperature for 24 hours. In both cases, no dissolution of LiF is observed.

To determine the influence of silane compounds, the experiments are repeated with the addition of in each case equimolar amounts of the silane. Table 1 shows the results obtained.

TABLE 1

| | 0.5 mol/l | 1.0 mol/l |
|---|---|---|
| Silane compound | of LiF | of LiF |
| Tetramethoxysilane | + | ∘ |
| Ethyltriacetoxysilane | ++ | + |
| Diphenylmethoxysilane | ++ | + |
| Difluorodiphenylsilane | ++ | ++ |
| Triethylsilyl | ++ | ++ |
| fluoromethanesulfonate | | |

∘: slight sediment
+: no sediment
++: no sediment, LiF is quickly dissolved

Ethyltriacetoxysilane, diphenylmethoxysilane, difluorodiphenylsilane and triethylsilyl fluoromethanesulfonate are able to dissolve LiF, with difluorodiphenylsilane and triethylsilyl fluoromethanesulfonate being particularly effective.

### Example 2

Oxidation Stability of the Silanes

In a measurement cell having a platinum working electrode, a lithium counterelectrode and a lithium reference electrode, 5 cyclovoltammograms are recorded in succession in each case. Here, the potential is firstly increased from the rest potential at a rate of 10 mV/s to 6.0 V relative to Li/Li⁺ and subsequently brought back to the rest potential.

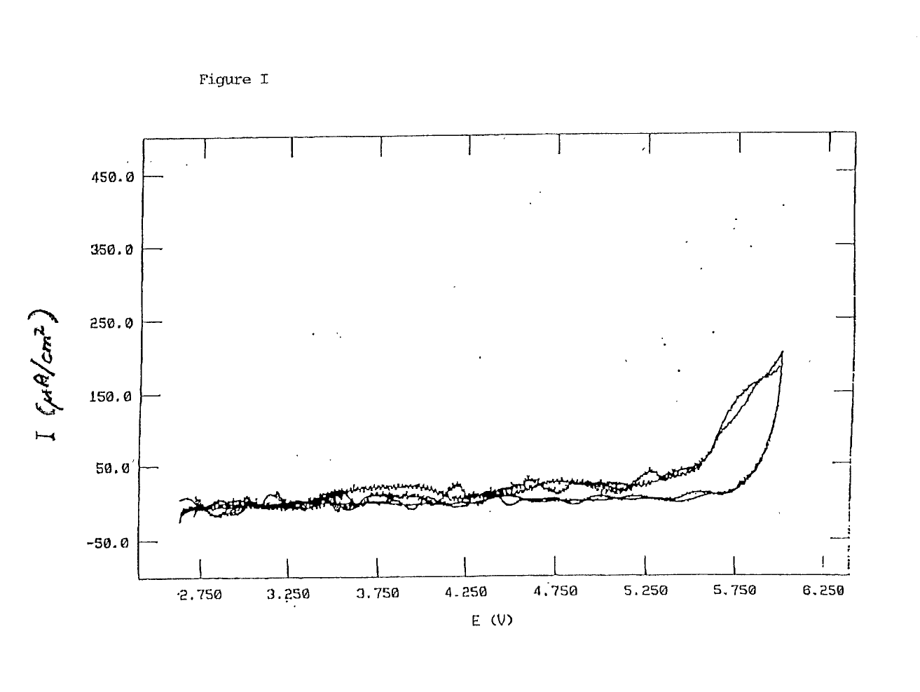

The electrolyte used is a 1 molar solution of LiPF₆ in EC/DMC which in each case contains 5% of silane additive. Table 2 shows the results obtained. FIG. 1 shows the cyclovoltammogram obtained using ethyltriacetoxysilane as additive.

TABLE 2

| Silane compound | Eₒₓ relative to Li/Li⁺ |
|---|---|
| Tetramethoxysilane | 4.4 V |
| Ethyltriacetoxysilane | 5.3 V |
| diphenylmethoxysilane | 4.8 V |
| Difluorodiphenylsilane | 5.5 V |
| Triethylsilyl | 5.2 V |
| fluoromethanesulfonate | |

All silanes have sufficient stability for use in electrochemical cells.

### Example 3

Cyclability of Graphite and LiMn₂O₄ in Silane-containing Electrolytes

Cycling experiments were carried out at room temperature and at 60° C. under galvanostatic conditions in half cells having a lithium counterelectrode and a graphite or LiMn₂O₄ working electrode.

For this purpose, 1% of the respective silane additive was added to an electrolyte consisting of 1 mol/l of LiPF₆ in EC:DEC:DMC (2:1:2).

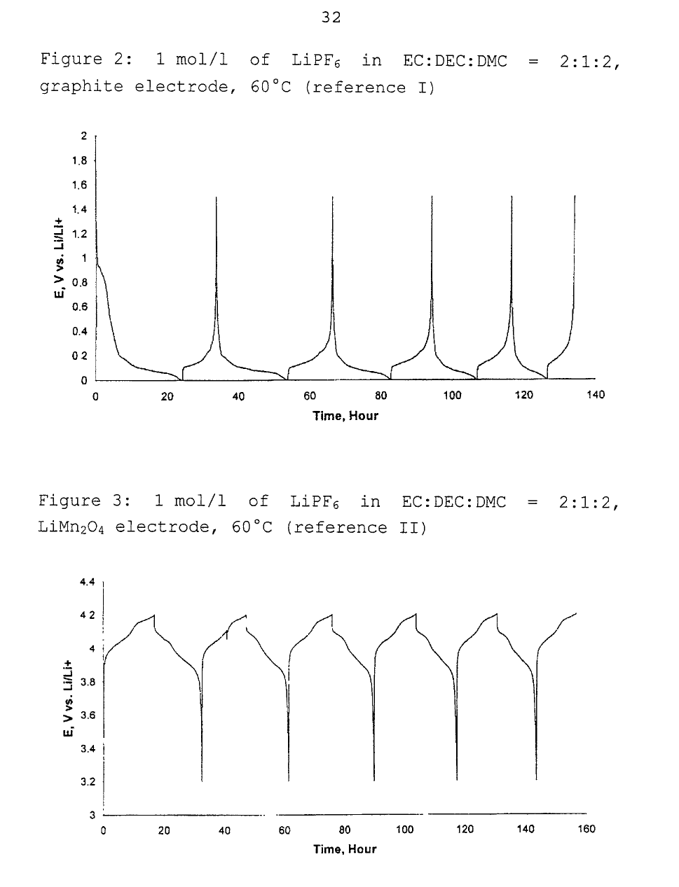

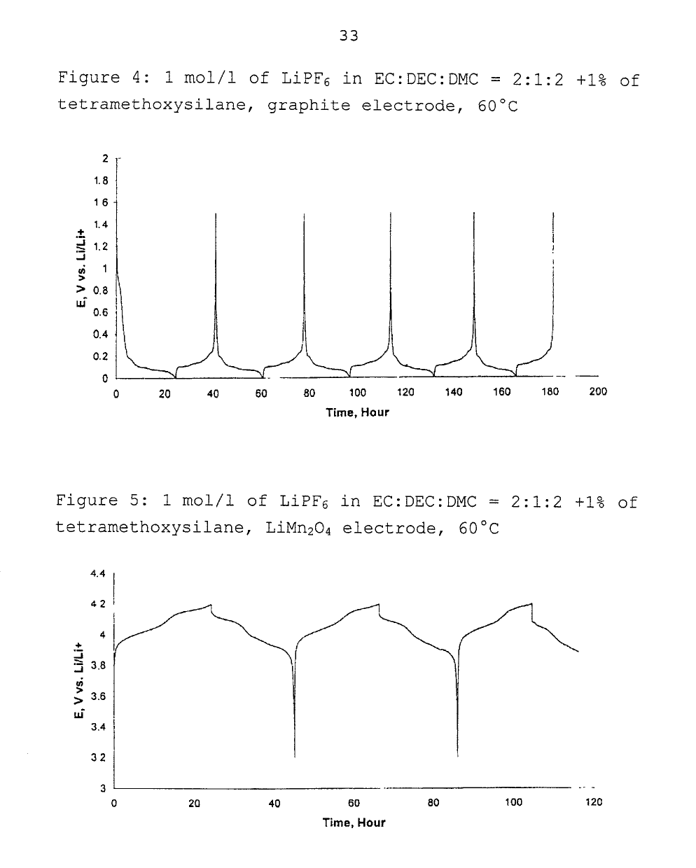

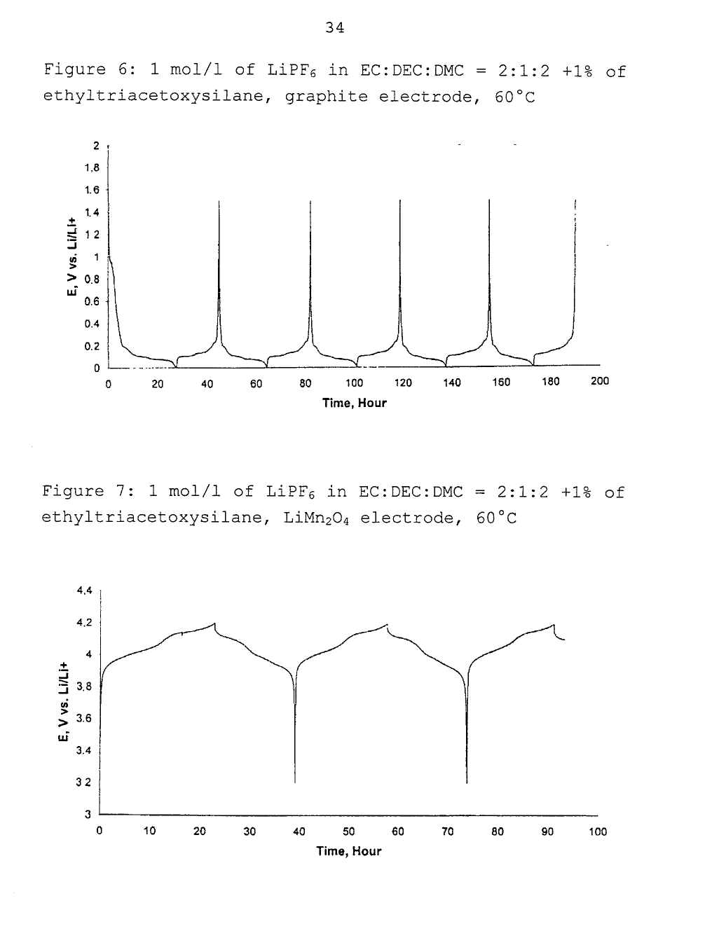

FIGS. 2-7 show the results of the cycling tests obtained at 60° C., with FIGS. 2 and 3 showing the results for the additive-free electrolyte as reference.

The cyclability of the electrodes both in respect of the cycle yield and the cycling stability can be improved by addition of silanes.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. An electrolyte composition comprising:
a lithium-containing inorganic electrolyte salt or lithium-containing organic electrolyte salt dissolved in an aprotic solvent or mixture of aprotic solvents, said composition further comprising at least one silane compound.

2. An electrolyte composition according to claim 1, wherein said at least one silane is a tetracoordinated silane compound.

3. An electrolyte composition according to claim 1, wherein said at least one silane comound is of formula (1)
SiR¹R²R³R⁴ (1)
wherein
R¹ to R⁴ are each, independently, H, C_{y}F_{2y+1-z}H_{z}, OC_{y}F_{2y+1-z}H_{z}, OC(O)C_{y}F_{2y+1-z}H_{z}, or OSO₂C_{y}F_{2y+1},
R¹ to R⁴ can each also be, independently, an aromatic group selected from phenyl and napthyl, which in each case is unsubstituted or mono- or polysubstituted by F, C_{y}F_{2y+1-z}H_{z}, OC_{y}F_{2y+1-z}H_{z}, OC(O)C_{y}F_{2y+1-z}H_{z}, OSO₂C_{y}F_{2y+1} or N(CₙF_{2n+1-z}), or
a heterocyclic aromatic group selected from pyridyl, pyrazyl and pyrimidyl which in each case is unsubstituted or mono- or polysubstituted by F, C_{y}F_{2y+1-z}H_{z}, OC_{y}F_{2y+1-z}H_{z}, OC(O)C_{y}F_{2y+1-z}H_{z}, OSO₂C_{y}F_{2y+1-z}H_{z}, or N(CₙF_{2n+1-z}H_{z})₂; and
1≦x<6, 1≦y≦8 and 0≦z≦2y+1.

4. An electrolyte composition according to claim 1, wherein said at least one silane compound is tetramethoxysilane, ethyltriacetoxysilane, diphenylmethoxysilane, difluorodiphenylsilane or triethylsilylfluoromethanesulfonate.

5. An electrolyte composition according to claim 1, wherein the amount of silane compounds present in said composition is 0.01-10% by weight.

6. An electrolyte composition according to claim 2, wherein the amount of silane compounds present in said composition is 0.01-10% by weight.

7. An electrolyte composition according to claim 3, wherein the amount of silane compounds present in said composition is 0.01-10% by weight.

8. An electrolyte composition according to claim 4, wherein the amount of silane compounds present in said composition is 0.01-10% by weight.

9. An electrolyte composition according to claim 5, wherein the amount of silane compounds present in said composition is 0.1-5% by weight.

10. An electrolyte composition according to claim 6, wherein the amount of silane compounds present in said composition is 0.1-5% by weight.

11. An electrolyte composition according to claim 7, wherein the amount of silane compounds present in said composition is 0.1-5% by weight.

12. An electrolyte composition according to claim 8, wherein the amount of silane compounds present in said composition is 0.1-5% by weight.

13. In an electrochemical cell comprising a cathode, an anode, a separator and an electrolyte, the improvement wherein the electrolyte is in accordance with claim 1.

14. In a battery comprising a cathode, an anode, a separator and an electrolyte, the improvement wherein the electrolyte is in accordance with claim 1.

15. In a secondary lithium battery comprising a cathode, an anode, a separator and an electrolyte, the improvement wherein the electrolyte is in accordance with claim 1.

16. A method of dissolving lithium fluoride comprising contacting lithium fluoride with a silane compound of the formula (1)
SiR¹R²R³R⁴ (1)
wherein
R¹ to R⁴ are each, independently, H, C_{y}F_{2y+1-z}H_{z}, OC_{y}F_{2y+1-z}H_{z}, OC(O)C_{y}F_{2y+1-z}H_{z}, or OSO₂C_{y}F_{2y+1},
R¹ to R⁴ can each also be, independently, an aromatic group selected from phenyl and napthyl, which in each case is unsubstituted or mono- or polysubstituted by F, C_{y}F_{2y+1-z}H_{z}, OC_{y}F_{2y+1-z}H_{z}, OC(O)C_{y}F_{2y+1-z}H_{z}, OSO₂C_{y}F_{2y+1} or N(CₙF_{2n+1-z}) , or
a heterocyclic aromatic group selected from pyridyl, pyrazyl and pyrimidyl which in each case is unsubstituted or mono- or polysubstituted by F, C_{y}F_{2y+1-z}H_{z}, OC_{y}F_{2y+1-z}H_{z}, OC(O)C_{y}F_{2y+1-z}H_{z}, OSO₂C_{y}F_{2y+1-z}H_{z}, or N(CₙF_{2n+1-z}H_{z})₂; and
1≦x<6, 1≦y≦8 and 0≦z≦2y+1.

17. A method according to claim 16 wherein said silane compound is used to dissolve lithium fluoride within a lithium ion battery.
